(19) United States
(12) Patent Application Publication
(10) Pub. No.: US 2026/0296681 A1
(43) Pub. Date: Oct. 1, 2026

(54) RADIATOR FOR THE DISSIPATION OF HEAT FROM A SPACECRAFT

(71) Applicants: Cezary Gasowski, Warszawa (PL); Krzysztof Kallas, Gdynia (PL)

(72) Inventors: Cezary Gasowski, Warszawa (PL); Krzysztof Kallas, Gdynia (PL)

(21) Appl. No.: 19/093,824

(22) Filed: Mar. 28, 2025

(51) Int. Cl. B64G 1/50; B32B 1/00; B32B 9/00; B32B 9/04

(52) U.S. Cl. CPC B64G 1/50; B32B 1/00; B32B 9/007; B32B 9/04; B32B 2307/302; B32B 2605/18

(57) ABSTRACT

The invention comprises a radiator for the dissipation of heat from a spacecraft in outer space that comprises radiator panel B made of a sheet of composite material that has an arc- or C channel-shaped cross-section and consists of structural layer 1 made of a flat spring, thermally conductive layer 2 made of a material characterised by a high conductivity coefficient, top layer 3 made of a material characterised by a high emissivity coefficient with infrared radiation and a low absorption coefficient in visible light frequencies, and binder layers, connected via the arched or C channel-shaped edge with spacecraft body A including, in the case of thermally conductive layer 2, thermally bonded with heat source 6.

### BACKGROUND

The present invention relates to a radiator used for the dissipation of heat from a spacecraft while it is present in outer space.

Thermal management systems are a very important part of a spacecraft, because maintaining the right operating temperature of the ship's components is a key element that allows it to achieve its objectives. The main tendency in recent year involves the use of small spacecraft, relatively smaller than those used previously, which generate particular problems with temperature management due to their low thermal mass, small external surface area, small volume coupled with tightly-packed heat-generating components, as well as limited capability to generate power that could be used for the thermal management of the spacecraft. Simultaneously, due to the growing demand for satellite data, the development of the space sector has combined with the growth of edge computing, which is based on the processing of data as close as possible to where it is generated. There is therefore a tendency to install increasingly more computing power on spacecraft and to utilise it more intensely as data processing centres, thus generating more heat, wherein this tendency is already becoming a bottleneck that reduces the ability to increase the computing power of electronic components.

In outer space, where high vacuum conditions prevail, heat can be dissipated from an emitter only using the effect of radiation. A radiator's heat-dissipating capability depends on: its surface area; the thermo-optical properties of the surface; the distribution of temperature on the radiator surface (more uniform temperatures mean better radiator efficiency), the temperature of background that is subject to emission from the radiator. radiators, especially in small spacecraft, are especially challenging due to the sheer limitation of the available external surface area of the spacecraft that could be used as a radiator, and due to the necessity of the installation of components such as sensors on the body of the spacecraft and, above all, elements such as photovoltaic cells, which interfere with the functioning of radiators. There is therefore the need for a deployable radiator, that would be capable of increasing the spacecraft's ability to dissipate heat during increased mission-related activity.

Known in the art are solutions which comprise of radiators in the form of hinged rigid panels that are provided with a mechanism that allows them to be folded and unfolded. The area of the radiator can be increased by adding more panels. These types of radiators occupy a substantial amount of storage space and have a high net weight, their manoeuvring in outer space is complicated and energy-consuming and requires the continuous control of the panel position and the locking the panel position after opening. One of the major problems is the provision of a thermal coupling at the hinged connection with the satellite body. This is usually resolved via the use of highly thermally conductive, yet flexible materials such as graphite, or by using flexible liquid-filled tubes that change their shape and thus the position of the radiator. It is a highly effective solution, but it is technically complex and expensive in terms of production and maintenance.

In others, the radiator is deployed using a passive mechanism made of shape-memory materials. Its additional feature is the combination of the functionalities of a radiator and a heat absorber, depending on the temperature. To enable this, the wall of the radiator is made of highly thermally conductive materials that are separated by an insulator. Another attempted solution is has the radiator rolled out, the operating principle based on the use of flexible, expandable heat pipes made of aluminium, with the application of acetone as the process fluid

### SUMMARY OF THE INVENTION

The proposed solution of a deployable radiator enables the resolution of the above problems. The radiator for the dissipation of heat from a spacecraft in outer space according to the invention comprises a radiator panel made of a sheet of composite material that has an arc- or C channel-shaped cross-section and consists of a structural layer made of a flat spring, a thermally conductive layer made of a material characterised by a high thermal conductivity coefficient, a top layer made of a material characterised by a high emissivity coefficient and a low infrared radiation absorption coefficient, and binder layers, connected via the arched or C channel-shaped edge with the spacecraft body including, in the case of the thermally conductive layer, directly thermally bonded with the heat source.

The flat spring that constitutes the structural layer, has either an arch-shaped or a C channel-shaped cross-section and may have the form of a C channel with rounded arms, as shown in FIGS. 1.2 and 1.3 of the drawings. It can extend under the entire thermally conductive layer, or as shown in FIGS. 1.1., 1.2. and 1.3 of the drawings only under a part of the thermally conductive layer, within strips extending from the lateral edges of the thermally conductive layer and longitudinally in relation to the radiator panel. The coil spring according to the invention is shaped in any case similarly to a measuring tape which, when deflected by being flattened, can be subjected to buckling in the transverse axis, enabling in particular the spring to be wound into a casing, while in the relaxed, i.e. the extended position, before buckling, the spring exhibits high transverse stiffness, which in particular enables the thermally conductive layer and the top layer of the radiator panel to be retained in an extended condition. When the spring is wound into the casing in one version shown of the solution shown in FIG. 3.1. or in another version of the solution shown in FIG. 2.1.-2.3. and when the radiator panel is folded adjacent to or in close proximity to the spacecraft body, the spring remains deformed and accumulates potential energy that can be used to automatically unfold the radiator panel when the interlock is released, while when the radiator panel is unfolded, the spring gives the radiator panel the necessary stiffness, which eliminates the need for any additional components for the stabilisation of the radiator panel in the working position.

The structural layer can be made of any material selected from the following group: spring steel, beryllium copper (CuBe), glass fibre-based composite, carbon fibre-based composite. The thermally conductive layer consists of a material characterised by a high thermal conductivity coefficient that enables the absorption of heat from the satellite, its distribution across the radiator panel and the emission of heat energy into outer space, while at the same time being a flexible material that maintains structural integrity and thermally conductive properties when the radiator panel is deformed. The thermally conductive layer can be especially made of pyrolytic graphite in the form of a film (Pyrolitic Graphite Sheet or Pyrolitic Graphite Foils), or applied using the CVD method directly onto the steel. The purpose of the top layer is to ensure that the external surface of the radiator panel has adequate thermo-optical properties. It is characterised by a low coefficient of absorption of light in the visible frequency range and a high coefficient of emissivity in the infrared range. As a result, the radiator absorbs low amounts of energy emitted by other bodies in outer space, especially the Sun, while ensuring effective heat radiation in the frequency range characteristic of a body with a temperature typical of a radiator. The purpose of this layer is also to provide protection against harmful environmental factors that are specific to LEO (Low Earth Orbit), such as atomic oxygen, UV radiation and solar wind. The top layer can be made of a material selected from the following group: lithium silicate-based paint, silverised Teflon, aluminised Teflon, SiO2, indium tin oxide (ITO). This layer can be applied onto the thermally conductive layer and the structural layer either directly or indirectly, i.e. first onto kapton films or FEP (fluorocarbon) films and then by gluing these films to the thermally conductive layer and to the structural layer using an adhesive. The above layers can be bonded using adhesives, especially using acrylic or silicone adhesives.

According to the first version of the invention, the radiator panel in its undeployed position is folded at a certain angle, while the loose end of the panel is attached to the spacecraft body in an adjacent or proximal manner using an interlock, especially using a Hold-Down and Release Mechanism. Depending on its slenderness, the radiator panel can have an arch-shaped cross-section as in FIGS. 1.4., 1.5. and 2.1. or a C channel-shaped cross-section, as in FIGS. 1.1, -1.3 and 2.2. When the interlock is released, the radiator panel is automatically deployed by the force of the structural layer returning to its original form. According to the second version of the invention, the radiator panel has a casing with a drum at its loose end and is rolled up into the casing with the drum in the undeployed position, wherein the casing with the drum is attached to the spacecraft body. According to this version of the invention, the casing with the drum can be provided with a reversible drive, powered from the spacecraft via a cable running through the thermally conductive layer, for the purposes of folding the radiator.

### BRIEF DESCRIPTION OF THE FIGURES

The solution according to the invention has been shown in form of an embodiment of the invention in the attached drawings, where the individual figures illustrate:

FIG. 1.1. A general view of the radiator panel according to the second version of the invention, with partial exposure of the thermally conductive layer and the structural layer

FIG. 1.2. A cross-section of the radiator panel according to the second version of the invention

FIG. 1.3. Detail A of FIG. 1.2. of the drawings

FIG. 1.4. A general view of the radiator panel according to the first version of the invention, with partial exposure of the thermally conductive layer and the structural layer

FIG. 1.5. A cross-section of the radiator panel according to the first version of the invention

FIG. 2.1 and A general view of two types of the foldable version of the radiator 2.2. with different slenderness ratios, in the undeployed and in the deployed position

FIG. 2.3. A side view of the connection between the radiator panel and the spacecraft body according to the foldable version of the radiator in the undeployed position

FIG. 3.1. A roll-up version of the radiator panel in the undeployed and in the deployed position

FIG. 3.2. A diagram of the connection of the radiator with a heat source located in the spacecraft body

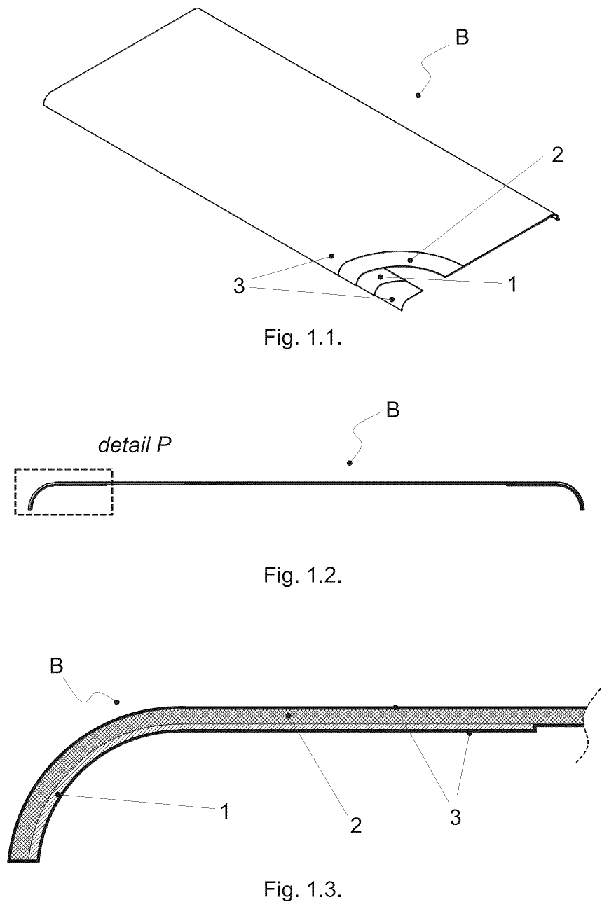

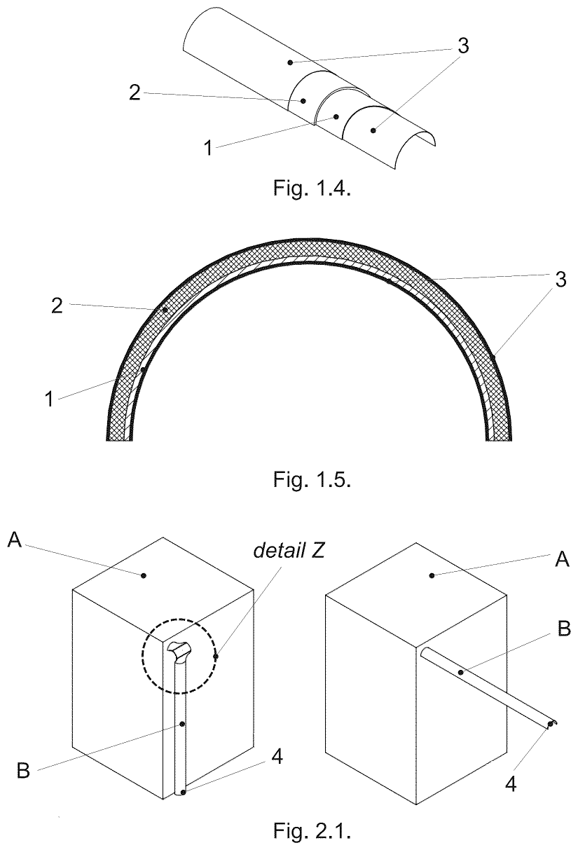

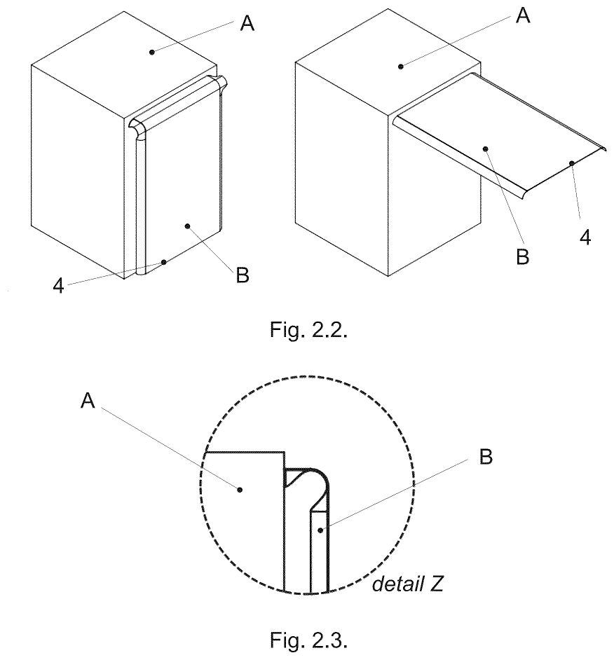

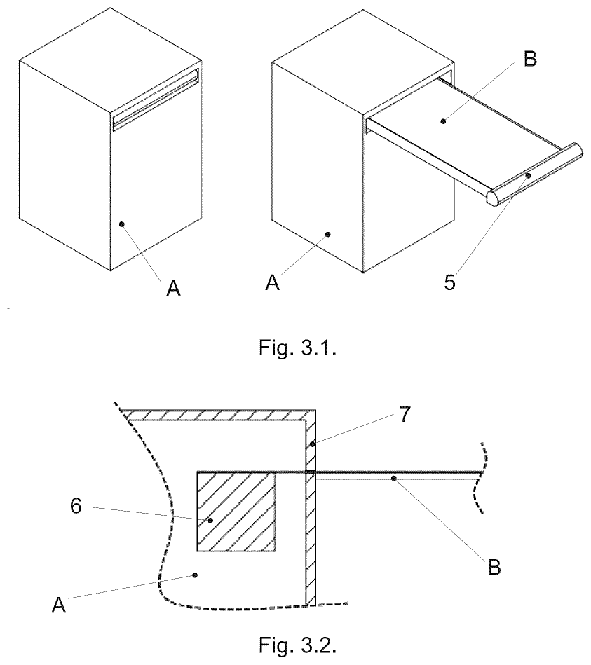

### DETAILED DESCRIPTION

According to a first embodiment of the invention, the radiator for the dissipation of heat from a spacecraft in outer space comprises a radiator panel B made of a sheet of composite material having an arched cross-section with the internal arc diameter of 50 mm and of the length of 500 mm measured from the base of satellite wall, consisting of a structural layer 1 made of a flat spring, a thermally conductive layer 2 made of a material characterised by a high thermal conductivity coefficient, a top layer 3 made of a material characterised by a high infrared emissivity coefficient and a low visible light absorption coefficient, as well as binder layers, connected via the arched edge with the spacecraft body A, including, in the case of the thermally conductive layer 2, a direct thermal connection with the heat source 6. Structural layer 1 of the thickness of 200 μm is made of type AISI 301 spring steel, the thermally conductive layer 2 of the thickness of 100 μm is made of type TG-829CR material manufactured by Neograf, while the top layer 3 of the thickness of 125 μm consists of silverised FEP foil manufactured by Dunmore. These layers are bonded together using type 966 PSA adhesive manufactured by 3M. Radiator panel B in the undeployed position is tilted at an angle of 90° by being hinged at its base, wherein the loose end of radiator panel 4 is attached adjacent to the spacecraft body 7 using a Hold-Down and Release Mechanism, which has not been shown.

According to a second embodiment of the invention, the radiator for the dissipation of heat from a spacecraft in outer space comprises a radiator panel B made of a sheet of composite material having a C channel-shaped cross-section, with the internal arc diameter of each of the C channel edges of 40 mm, the total width between the panel edges of 300 mm and of the maximum length of projection of the panel beyond the satellite wall of 1500 mm, consisting of a structural layer 1 made of a flat spring, a thermally conductive layer 2 made of a material characterised by a high thermal conductivity coefficient, a top layer 3 made of a material characterised by a high emissivity coefficient and a low infrared radiation absorption coefficient, as well as binder layers, connected via the arched edge with the spacecraft body A, including, in the case of the thermally conductive layer 2, a direct thermal connection with the heat source 6. Structural layer 1 of the thickness of 200 μm is made of type CuBe2 berillium copper, the thermally conductive layer 2 of the thickness of 200 μm is made of type TG-829CR pyrolytic graphite manufactured by Neograf, while the top layer 3 of the thickness of 250 μm consists of aluminised teflon foil manufactured by Dunmore. These layers are bonded together using type 966 PSA adhesive manufactured by 3M. When in the undeployed position, radiator panel B is rolled up into the casing with drum 5, wherein the casing with drum 5 is located inside body 7 of the spacecraft. Casing with drum 5 is provided with a reversible drive powered from the spacecraft via a cable running inside the thermally conductive layer 2, not shown in the illustration.

### LIST OF DESIGNATIONS

A spacecraft
B Radiator panel
1 structural layer
2 thermally conductive layer
3 top layer
4 loose end of the radiator panel
5 casing with drum
6 heat source
7 spacecraft body

1. A radiator for the dissipation of heat from a spacecraft in outer space, comprising; a radiator panel B made of a sheet of composite material that has an arched or C channel-shaped cross-section the composite material comprising a structural layer made of a flat spring, a thermally conductive layer made of a material with a high thermal conductivity coefficient, a top layer made of a material with a high emissivity coefficient with infrared radiation and a low absorption coefficient in visible light frequencies, and at least one binder layer, operably connected via an edge of the arched or C channel-shaped to a spacecraft body wherein the thermally conductive layer is, a thermally bonded to the spacecraft body.

2. The radiator according to claim 1, wherein the structural layer is a spring steel, a beryllium copper (CuBe), a glass fibre based composite, or a carbon fibre based composite layer, the thermally conductive layer is made of a pyrolytic graphite and the top layer is a lithium silicate-based paint, a silverised FEP or a PTFE, an aluminised FEP or PTFE, a SiO₂, a indium tin oxide (ITO) layer.

3. The radiator according to claim 1, further comprising a radiator panel in an undeployed position tilted at a certain angle from the radiator, while a loose end of the radiator panel is attached to a spacecraft body using an interlock.

4. The radiator according to claim 2, wherein a radiator panel is in an undeployed position tilted at a certain angle from the radiator, while a loose end of the radiator panel is attached to a spacecraft body using an interlock.

5. The radiator according to claim 1, further comprising a radiator panel that has a casing with a drum at a loose end of the radiator panel and when in an undeployed position, the radiator panel is rolled up into the casing with the drum, wherein the casing with the drum is attached to or located inside the spacecraft body.

6. The radiator according to claim 2, further comprising a radiator panel that has a casing with a drum at a loose end of the radiator panel and when in an undeployed position, the radiator panel is rolled up into the casing with the drum, wherein the casing with the drum is attached to or located inside the spacecraft body.

7. The radiator according to claim 5, wherein the casing with the drum is provided with a reversible drive powered from a spacecraft via a cable running inside the thermally conductive layer.

8. The radiator according to claim 6, wherein the casing with the drum is provided with a reversible drive powered from a spacecraft via a cable running inside the thermally conductive layer.
